(19) United States
(12) Patent Application Publication
(10) Pub. No.: US 2010/0129766 A1
(43) Pub. Date: May 27, 2010

(54) ORTHODONTIC RETRACTION ARCH AND SPRING

(75) Inventor: James Jay Hilgers, Rancho Santa Fe, CA (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/443,985

(22) PCT Filed: Oct. 10, 2007
(86) PCT No.: PCT/US07/80942

§ 371 Date: Nov. 13, 2009

Related U.S. Application Data
(60) Provisional application No. 60/850,624, filed on Oct. 10, 2006.

(51) Int. Cl. A61C 7/20

(52) U.S. Cl. 433/20; 433/21

(57) ABSTRACT

An orthodontic retraction arch (10) includes an arch section (12) and two distal spring sections (14). Distal ends of spring sections (14) have eyelets (16) for ligation to orthodontic implants (18). An orthodontic retraction spring (20) has first and second spring segments (22, 24) and structures to engage an archwire (a crimpable archwire slot 28) and an orthodontic implant 18 (an eyelet 26). Retraction arch (10) and retraction spring (20) may also include recumbant loops (15, 23).

### PRIORITY CLAIM

This application claims the benefit of U.S. Provisional Patent Application Ser. No. 60/850,624, filed Oct. 10, 2006 and entitled “Orthodontic Devices, Implants and Related Apparatus,” the disclosure of which is expressly incorporated by reference herein in its entirety.

### TECHNICAL FIELD

The present invention generally relates to orthodontic devices, and more particularly, to orthodontic retraction arches and springs, including recumbent loops.

### BACKGROUND

It is estimated that about 60% of orthodontic starts demonstrate Class II tendencies (i.e., “overbite”). These cases are typically treated via the use of fixed appliances or intra-oral elastics. However, a percentage of these cases are treated by extracting teeth (typically 1^{st} bicuspids) from the maxilla and then retracting the anterior teeth distally in order to the close this newly opened space. While such a method is effective in resolving the anterior/posterior relationships in the case, it does not address any vertical corrections that may be required in a Class II deep bite case. Resolving this vertical relationship typically requires a separate solution that targets placing an intrusive force on the anterior teeth.

What is needed is an orthodontic appliance that addresses both Class II tendencies and vertical corrections.

### SUMMARY

In one aspect, the present invention is a retraction arch. This arch is made of a suitable metal with elastic properties (e.g. NiTi) and may extend from cuspid to cuspid. Alternatively, the arch may extend from central to cuspid if only a unilateral space closure is called for (i.e., a space closure on one side of the arch only created by an extraction). The arch wire may be round or rectangular in cross-section, depending on whether the clinician desires torque control while closing the space. Once positioned in the patient's mouth and affixed to the appropriate teeth, the arch is activated by uprighting a set of spring arms (located at the distal ends of the arch and including a recumbent loop) and affixing them, such as by ligation, to a pair of orthodontic implants or mini-screws previously implanted in the patient's mouth. Once activated, the arch provides both distilizing and intrusive force vectors.

As an alternative to the retraction arch similar distalizing end intrusive force vectors may be created on a tooth-by-tooth basis utilizing a retraction spring that includes a crimpable arch wire slot at one end and an eyelet at the other end for attachment to an orthodontic implant. The retraction spring is essentially the same as the distal ends of the retraction arch, including a recumbent loop, but includes the additional element of a structure that facilitates engagement with an arch wire. That structure may be a crimpable archwire slot or a wire segment that is receivable in an orthodontic bracket.

### BRIEF DESCRIPTION OF THE DRAWINGS

Various additional features and aspects will become readily apparent to those of ordinary skill in the art from the following description of illustrative embodiments of the invention and from the drawings in which:

FIG. 1 is a perspective view of a retraction arch of the present invention;

FIG. 2 is a perspective view of the retraction arch of FIG. 1 shown in an activated orientation;

FIG. 3 is a retraction spring in an unactivated position;

FIG. 4 is a perspective view showing the retraction spring of FIG. 3 in an activated position;

FIG. 5 is an alternative embodiment of a retraction spring of the present invention;

FIG. 6 is a perspective view of the retraction spring of FIG. 5 shown in an activated orientation;

FIG. 7 is a perspective view showing the retraction spring of FIGS. 5 and 6 in an activated orientation within the oral cavity of a patient; and

FIG. 8 is a perspective view showing an alternative embodiment of a retraction spring of the present invention along with a stabilizing anchor.

### DETAILED DESCRIPTION

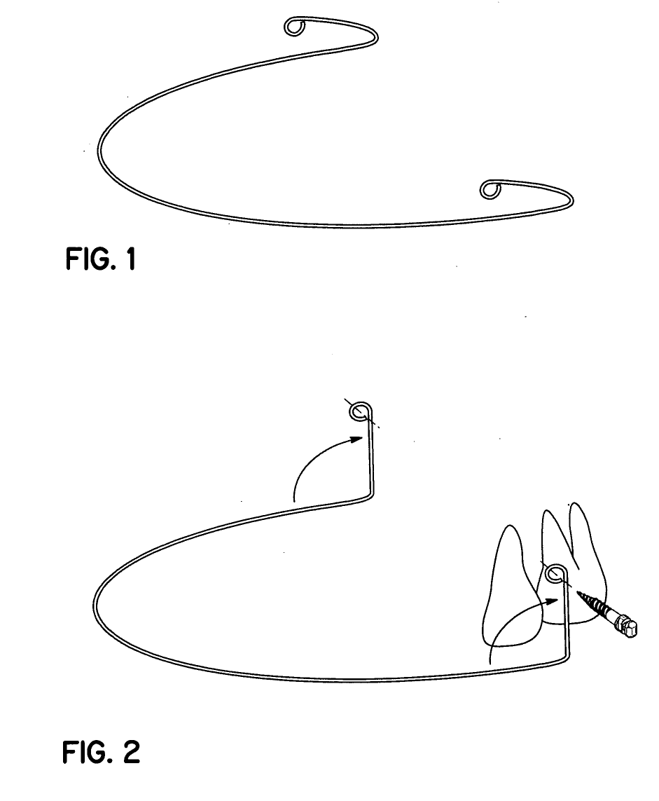

FIGS. 1 and 2 show a retraction arch 10 in accordance with the present invention. As shown, the retraction arch has an arch portion 12 and two distal spring portions 14. FIG. 1 shows the retraction arch 10 in a rest position and FIG. 2 shows retraction arch 10 in an activated position wherein the distal spring members 14 have been positioned into a generally upright orientation. Recumbant loops 15 are located at the transition from arch portion 12 to spring members 14 to provide force reduction to spring members 14. As shown specifically in FIG. 2, the distal-most end of the upright spring members 14 includes a ball, hook or eyelet 16 which is designed to be ligated to an orthodontic implant 18, such as with a ligature wire 19, to hold the distal end of retraction arch 10 in a fixed position in the oral cavity. With this configuration, the orthodontic retraction arch 10 can provide the necessary distalizing or retracting force on the teeth to which the arch segment 12 is attached to directly address Class II malocclusions. Orthodontic implant 18 may be any suitable implant known in the art. In particular, implant 18 may be one of the types disclosed in co-pending PCT International application No. ______, filed Oct. 10, 2007, entitled “Orthodontic Implants,” which is expressly incorporated by reference herein in its entirety.

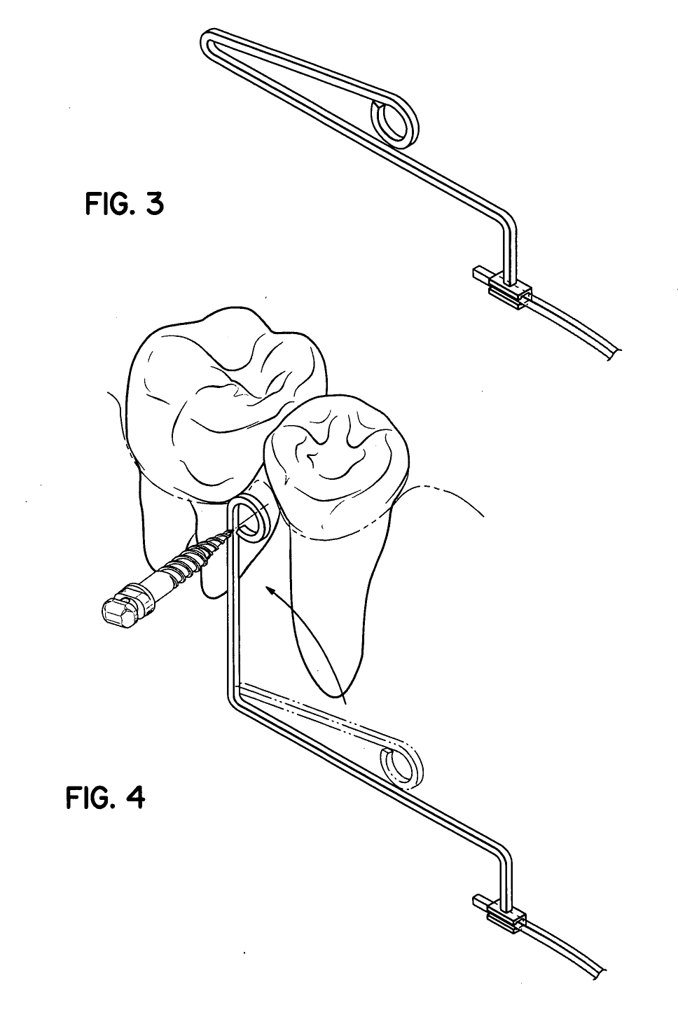

FIGS. 3 and 4 show an alternative embodiment of the present invention in the form of a retraction spring or pinch-on recumbent loop 20. Retraction spring 20 has a first segment 22 and a second segment 24 which are shown at rest in FIG. 3. Recumbant loop 23 is positioned between first and second segments 22 and 24. In the context of retraction arch 10 and retraction spring 20, one material that is particularly advantageous is a NiTi alloy having shape memory properties. Furthermore, in the context of the retraction arch 10, the cross-section of the arch segment may be circular or square depending on whether torquing is desired.

With respect to FIG. 4, retraction spring 20 is shown wherein the second segment 24 is in an upright or active position and ready for engagement with an orthodontic implant 18 by ligation (such as with ligation wire 19) to the eyelet or ball hook 26 at the distal-most end of segment 24. The forward-most end of the first segment 22 of retraction spring 20 is shown having a crimpable arch wire slot member 28 affixed thereto. This configuration allows the clinician to attach the retraction spring 20 to the patient's jaw at a distal end (via ligation to implant 18) and to an arch wire 30 via the arch wire crimpable portion 28 to provide the desired tipping, tilting, intruding, rotating, or other desired forces, depending on the spatial orientation of the distal end 26 and anterior end 28.

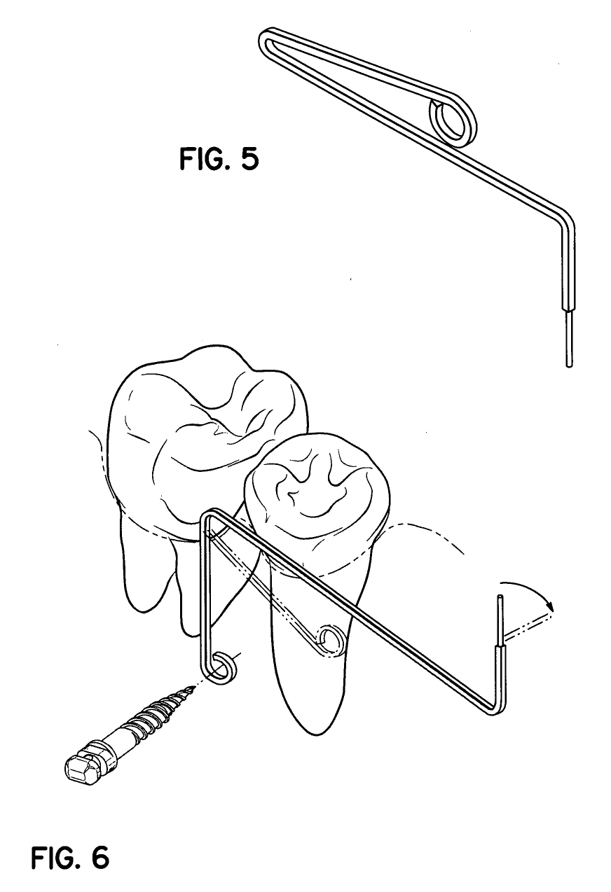

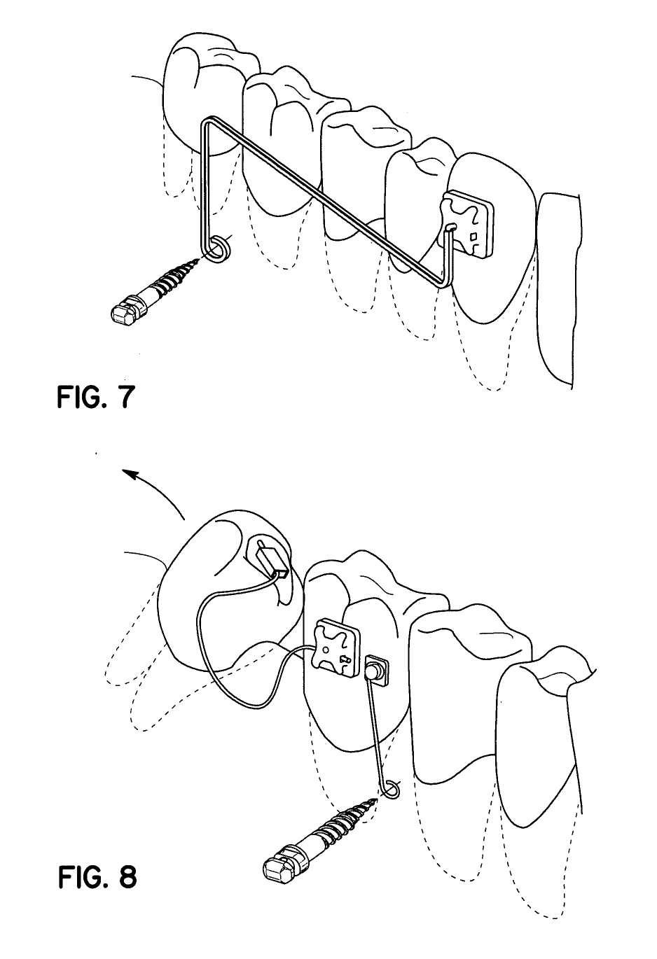

FIGS. 5-7 show an alternative embodiment of retraction spring 20a wherein the spring has an anterior segment of reduced diameter 40 which is designed to be bent into an orientation such as that shown in FIG. 6 for being received into a vertical slot 42 in a tooth bracket 44 as shown in FIG. 7. The distal end of retraction spring 20a also includes a suitable eyelet or hook member 26 for ligation (as by wire 19) to an orthodontic implant 18 as shown in FIGS. 6 and 7. As will be appreciated, the placement of implant 18 in the patient's mouth vis-à-vis the location of bracket 40 on a patient's tooth, will result in a desired force vector on the tooth.

FIG. 8 shows an alternative embodiment of a retraction spring 60 in which a first end 61 is received in a bracket 64 attached to a patient's tooth 56 and the distal end 63 is received in a bonding tube 65 of the type disclosed in co-pending PCT International Application No. ______ filed Oct. 10, 2007 entitled “Tooth Bonding Pad with Wire Retaining Portions And Related Methods,” which is expressly incorporated by reference herein in its entirety. The spring 60 tends to drive tooth 70 in the direction of arrow 62 to provide a tilting force thereto. In order for that to be accomplished without compromising the orientation of tooth 56, to which retraction spring 60 is also connected, requires the use and placement of button or ball hook member 54 on tooth 56, which includes an anchor member 50 that has a receiving hook 52 at an end thereof for ligation (as by wire 19) to an orthodontic implant. When orthodontic implant 18 is implanted into the patient's jaw and ligated to the receiving eyelet or hook 52 the tooth 56 is anchored in position relative to any force vectors created by the forces applied to tooth 70.

While the present invention has been illustrated by description of one or more embodiments and while these embodiments have been described in detail, it is not the intention of the applicant to restrict or in any way limit the scope of the claims to such detail. Additional advantages and modifications will readily appear to those skilled in the art. The invention in its broader aspects is, therefore, not limited to the specific details, representative systems, apparatus and method, and illustrative examples shown and described. Accordingly, departures may be made from such details without departing from the spirit or scope of the applicant's inventive concept.

What is claimed is:

1. An orthodontic retraction arch, comprising:
an arch-shaped wire for engagement to at least two teeth in a dental arch, said arch-shaped wire having a first spring segment at a first distal end thereof and a second spring segment at a second distal end thereof, said first and second spring segments each having a connector at the distal end thereof adapted to engage an orthodontic implant, and a recumbent loop intermediate said first and second spring segments.

2. The orthodontic retraction arch of claim 1 wherein said arch-shaped wire has a circular cross-section.

3. The orthodontic retraction arch of claim 1 wherein said arch-shaped wire has a rectangular cross-section.

4. The orthodontic retraction arch of claim 1 wherein said arch-shaped wire is made of a shape-memory material.

5. The orthodontic retraction arch of claim 1 wherein the connector for engaging an orthodontic implant is an eyelet or a hook.

6. An orthodontic retraction spring, comprising:
a first wire segment;
a second wire segment;
a spring segment intermediate said first and second wire segments for providing a spring force upon activation of said retractor spring.

7. The orthodontic retraction spring of claim 6 wherein said first wire segment includes at its distal end a structure for engaging an archwire.

8. The orthodontic retraction of claim 6 wherein said second wire segment includes at its distal end a structure for engaging as orthodontic implant.

9. The orthodontic retraction of claim 7 wherein said archwire engaging structure is a crimpable archwire slot or tube.

10. The orthodontic implant of claim 7 wherein said orthodontic implant engaging structure is an eyelet.

11. The orthodontic implant of claim 6 wherein said spring segment includes a recumbent loop.
